(19) United States
(12) Patent Application Publication
(10) Pub. No.: US 2010/0077211 A1
(43) Pub. Date: Mar. 25, 2010

(54) BIT-ERROR RATE TESTER WITH PATTERN GENERATION

(75) Inventor: Yongman Lee, Pleasanton, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: Apple Inc., Cupertino, CA (US)

(21) Appl. No.: 12/499,982

(22) Filed: Jul. 9, 2009

Related U.S. Application Data
(60) Provisional application No. 61/099,848, filed on Sep. 24, 2008.

(51) Int. Cl. G06F 11/26; H04L 9/32

(52) U.S. Cl. 713/168; 714/32; 714/E11.159

(57) ABSTRACT

Identical random, or pseudorandom, test patterns in a peripheral device (“receiver”) to be tested, and in a transmitter that sends the test pattern to the receiver, are generated by using pattern generation circuitry in both the transmitter and the receiver that operates identically based on a pattern input value, or seed. The same seed is input to both the transmitter and the receiver. The pattern generation circuitry can be a linear-feedback shift register (“LFSR”), which generates pseudorandom numbers, and identical LFSRs in both the transmitter and the receiver are provided with the same seed. The LFSR may be reseeded periodically. The new seed can be an output of the LFSR itself, or a second LFSR is provided whose output is used to determine the new seed for the first LFSR. Alternatively, cryptographic modules are used in the transmitter and the receiver to generate the test pattern based on identical keys.

### CROSS REFERENCE TO RELATED APPLICATION

This claims the benefit of copending, commonly-assigned U.S. Provisional Patent Application No. 61/099,848, filed Sep. 24, 2008, which is hereby incorporated by reference herein in its entirety.

### BACKGROUND OF THE INVENTION

This relates to the testing of a peripheral device associated with an electronic device.

Many kinds of portable electronic devices include processors or systems-on-a-chip (SOCs) that communicate with peripheral components such as memory, displays, or various transducers. In the assembly of such electronic devices, the various components normally will have been tested individually in advance, but it is nevertheless important to test the communications between the components of the assembled devices.

Such testing normally includes the transmission of a test pattern to the peripheral device. The peripheral device compares the pattern as received to the known pattern it is expecting to receive, to determine the bit error rate. There are several ways that the receiver in the peripheral device can know what pattern to expect. One way is to simply send a predetermined pattern, of which one of the simplest examples is a pattern of alternating 1's and 0's. However, such a pattern is more susceptible to corruption than a more random pattern. Therefore, the bit error rate tester in the receiver of the peripheral device operates better with a more random data pattern.

### SUMMARY OF THE INVENTION

Where a random data pattern is used for test purposes, the test pattern to be compared cannot be sent to the peripheral device in advance. Therefore, it must be generated locally, at the peripheral device, using the same pattern generation rule that is used at the transmitter to send the test pattern.

The present invention provides for the generation of identical random, or pseudorandom, test patterns in a peripheral device (“receiver”) to be tested, and in a transmitter that sends the test pattern to the receiver, by using pattern generation circuitry in both the transmitter and the receiver that operates identically and requires a pattern input value, or seed. The same seed value is input to both the transmitter and the receiver. For example, the seed value can be provided to the receiver off-line, before testing begins.

In a first variant of a first embodiment, the pattern generation circuitry can be a linear-feedback shift register, which generates pseudorandom numbers. If identical linear-feedback shift registers are provided in both the transmitter and the receiver, and both linear-feedback shift registers take the output of the same feedback register tap as their respective outputs, then both linear-feedback shift registers will provide the same pseudorandom pattern.

Because the pattern of a linear-feedback shift register is not truly random, but only pseudorandom, the pattern will repeat every 2ⁿ cycles, where n is the length of the linear-feedback shift register in bits. Therefore in a second variant of the first embodiment, the pattern generation circuitry is reseeded periodically. In one variant of this embodiment, the new seed is an output of the linear-feedback shift register itself. For example, it can be predetermined that every mth output of the linear-feedback shift register (m≦n) will be used as a new seed. In another variant of this embodiment, a second linear-feedback shift register is provided whose output is used to determine the new seed for the first linear-feedback shift register.

In a second embodiment, identical cryptographic modules are used in the transmitter and the receiver to generate the test pattern. Identical keys may be provided to the cryptographic modules in a manner similar to the provision of the seed in the foregoing linear-feedback shift register embodiments.

Therefore, in accordance with embodiments of the invention, there is provided a system including a peripheral component of an electronic device, the peripheral component having a driver including testing circuitry. The testing circuitry includes receiver pattern circuitry for generating a varying receiver test pattern based on a receiver pattern input value. The system also includes apparatus for testing the peripheral component, which apparatus includes transmitter pattern circuitry for generating a varying transmitter test pattern, and circuitry for sending the transmitter test pattern to the testing circuitry. The receiver pattern circuitry and the transmitter pattern circuitry operate identically, such that the receiver test pattern and the transmitter test pattern are identical when the receiver pattern input value and the transmitter pattern input value are identical. The system further includes input circuitry for inputting a seed value as both the receiver pattern input value and the transmitter pattern input value, and comparator circuitry in the testing circuitry that compares the transmitter test pattern received from the testing apparatus to the receiver test pattern.

A peripheral component for such a system, including testing circuitry as described, and a testing method using such testing circuitry, also are provided.

### BRIEF DESCRIPTION OF THE DRAWINGS

Further features of the invention, its nature and various advantages, will be apparent upon consideration of the following detailed description, taken in conjunction with the accompanying drawings, in which like reference characters refer to like parts throughout, and in which:

FIG. 1 is a diagram of a testing arrangement for a peripheral component of an electronic device, using testing circuitry in accordance with an embodiment of the present invention; and

FIG. 2 is a diagram of a testing arrangement for a peripheral component of an electronic device, using testing circuitry in accordance with another embodiment of the present invention.

### DETAILED DESCRIPTION

A peripheral component may be designed to communicate with its host processor using a serial protocol may be tested by a testing apparatus operating under that protocol. In the embodiments described herein, the Mobile Industry Processor Interface (MIPI) protocol, administered by the Mobile Industry Processor Interface Alliance, is an example of such a serial protocol.

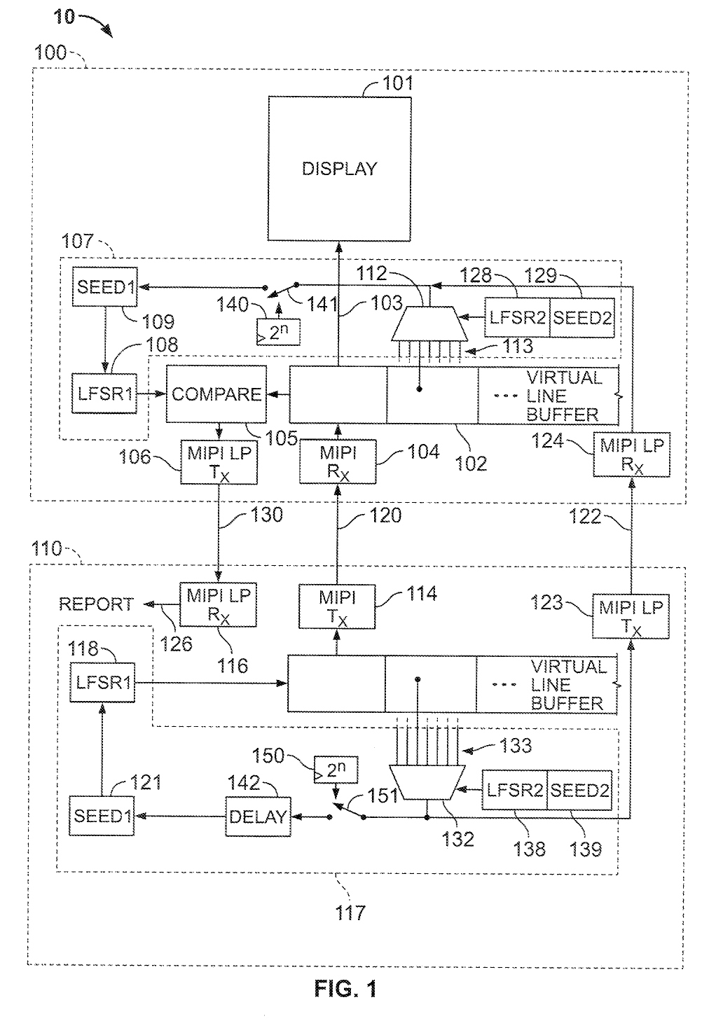

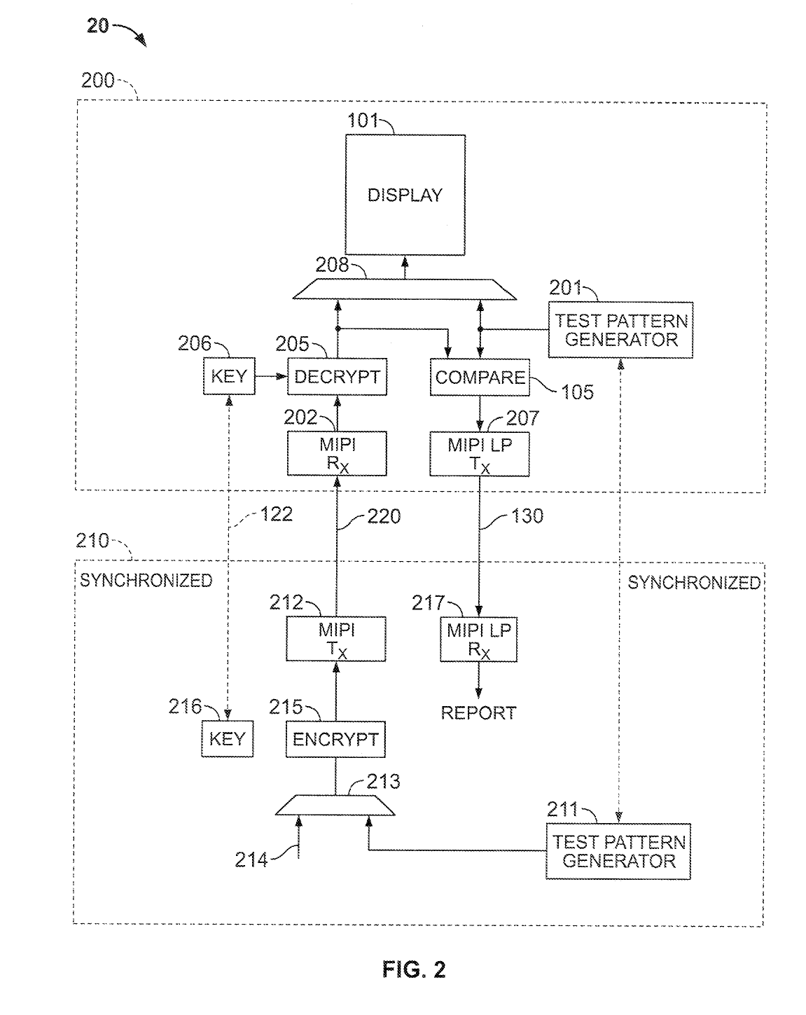

The invention may be described with reference to FIGS. 1-2, which describe, as an example, the testing, using the MIPI protocol, of a display module (e.g., a liquid-crystal display (LCD) module) used in a portable device that operates under the MIPI protocol. It will be recognized, however, that references to an LCD module and to the MIPI protocol are exemplary only.

As seen in FIG. 1, in one embodiment of a testing system 10 according to the invention device 100 includes testing circuitry to test display module 101, which may be an LCD panel. Device 100 includes, in addition to display module 101, a processor (not shown) and a high-speed serial interface (HSSI) receiver 104 such as a MIPI interface receiver. Video signals received by MIPI interface receiver 104 may be buffered into line buffer 102 (which may be part of a larger display driver circuit (not shown)), before being passed to display module 101 via line 103. Use of a serial interface allows, for example, the reduction of the number of wires/pins needed to transmit RGB video data to display 101 from 24 wires (eight bits for each of the three color signals) to six wires.

Testing system 10 may also include a testing module 110 which may send a test pattern or series of test patterns to device 100 via serial link 120, using a high-speed serial interface transmitter 114 compatible with high-speed serial interface receiver 104 (e.g., a MIPI interface transmitter). The test pattern received by device 100 may be compared in comparator 105 to an expected pattern, and the results (e.g., the number of errors divided by the number of comparisons) of the comparison reported by serial transmitter 106 over serial link 130. Serial transmitter 106 preferably operates under the MIPI protocol as well, but may operate in the MIPI low-power, or LP, mode, which is slower than the standard MIPI mode, resembling standard CMOS signaling, and may be less prone to errors. The error report may be received by a receiver 116 in testing module 110 at output at 126 for review.

As discussed above, the expected test pattern that is compared by comparator 105 to the received test pattern should be identical to the received test pattern. This may be achieved by having receiver test pattern generation circuitry 107 in device 100 and transmitter pattern generation circuitry 117 in testing module 110 that operate identically. In order to provide more robust test conditions, the test patterns should be as random, or in practice pseudo-random, as possible.

In one embodiment, this may be accomplished by providing identical linear-feedback shift registers 108, 118 in device 100 and testing module 110, respectively. An initial seed value may be preloaded into register 121 in testing module 110 and may be uploaded from there to device 100 via link 122, which preferably is a MIPI LP mode link which, as set forth above, is less prone to error, thereby increasing the likelihood that the seed value will not be corrupted in transmission to register 109 of device 100. Although link 122 and its transmitter 123 (in testing module 110) and receiver 124 (in device 100) are shown as being separate from link 130, it may be the same link.

Testing system 10 may thus be initially seeded, and will produce sufficiently random patterns for testing. The pattern will be produced at transmitter pattern generation circuitry 117 in testing module 110 and sent to device 100 for testing. Because receiver test pattern generation circuitry 107 in device 100 operates identically to transmitter pattern generation circuitry 117 in testing module 110, and is identically seeded, in the absence of error the two inputs to comparator 105 should be identical and therefore any differences detected by comparator 105 are indicative of error. However, the linear-feedback shift register output in transmitter pattern generation circuitry 117 and receiver pattern generation circuitry 107 will repeat after 2ⁿ cycles, where n is the bit length of the linear-feedback shift register. Therefore, according to embodiments of the invention, testing system 10 may be periodically reseeded to maintain sufficient randomness in the test patterns.

According to a first variant of one embodiment, the linear-feedback shift registers 108, 118 in the receiver and transmitter pattern generation circuits 107, 117 can be reseeded periodically with their own outputs. Respective counters 140, 150 loaded with the value 2ⁿ can be used to trigger the closure, after 2ⁿ clock cycles, of respective switches 141, 151 that connect a predetermined portion of the respective shift register outputs to the inputs of respective seed registers 109, 121. Because linear-feedback shift registers 108, 118 are synchronized, the seeds will be the same and linear-feedback shift registers 108, 118 will remain synchronized.

In a second variant of this embodiment, to further randomize the test patterns, optional multiplexers 112, 132 can be included in receiver and transmitter pattern generation circuits 107, 117. The various respective inputs 113, 133 of multiplexers 112, 132 can be connected to corresponding different portions (only one shown) of the registered outputs of linear-feedback shift registers 108, 118. The outputs of respective second linear-feedback shift registers 128, 138 can be used as the respective control signals for multiplexers 112, 132. Second linear-feedback shift registers 108, 118 can be commonly seeded (129, 139) initially in the same manner as linear-feedback shift registers 108, 118, so that the subsequent seeds that second linear-feedback shift registers 128, 138 select for first linear-feedback shift registers 108, 118 remain synchronized.

In a third variant of this embodiment, instead of providing multiplexers 112, 132 and second linear-feedback shift registers 128, 138, only multiplexer 132 and second linear-feedback shift register 138 could be provided, so that any new seed for first linear-feedback shift registers 108, 118 is derived only in testing module 110. That seed can be communicated to first linear-feedback shift register 108 in display module 100 via line 122. In this variant, optional delay 142 may be provided between multiplexer 132 and seed register 121, so that the arrival of the new seed at seed register 121 is delayed until the new seed arrives at seed register 109.

In a second embodiment 20, shown in FIG. 2, randomness (or pseudorandomness) of the test patterns may be maintained using cryptographic techniques.

In testing system 20, display module 200 again includes display panel 101, as well as test pattern generator 201. Testing module 210 also includes a test pattern generator 211 which may operate identically to, and may be synchronized with, test pattern generator 201. Testing module 210 includes a transmitter 212 operating under a suitable protocol such as the MIPI protocol, while display module 200 includes a receiver 202 operating under a suitable protocol such as the MIPI protocol. Transmitter 212 and receiver 202 may be interconnected by a suitable communication link 220. Transmitter multiplexer 213 allows the selection of output of test pattern generator 211, or an alternate source 214, for transmission to display module 200.

Prior to transmission, the signal selected by transmitter multiplexer 213 may be encrypted using any suitable encryption technique (such as, e.g., DES) in transmitter encryption module 215, to effectively randomize the test pattern. A corresponding decryption module 205 in display module 200, using a corresponding decryption technique, may be provided to decrypt the test pattern after it is received by receiver 202. The encryption and decryption techniques of encryption module 215 and decryption module 205 may require a key, and corresponding keys may be preloaded into key registers 206, 216. Those key values may be fixed, or may be updated at appropriate intervals or when a testing operator so desires. As in the case of embodiment 10, the key value may be loaded into register 206—e.g., using MIPI low-power mode—over link 122 which, again, may be the same link as link 130.

The output of receiver test pattern generator 201, as well as the decrypted received test pattern output by decryption module 205, may be input to comparator 105, which may transmit its bit-error rate report via link 130 to testing module 210. Again, link 130 may operated in the MIPI low-power mode, including MIPI-LP transmitter 207 and MIPI-LP receiver 217.

Input multiplexer 208 of display module 200 allows selection of either externally generated test pattern output from decryption module 205, or the locally generated test pattern from test pattern generator 201, to be displayed on display module 101 for the benefit of a human testing operator. When display module 200 has passed testing and is incorporated into an electronic device, input multiplexer 208 will be set to select the externally generated signal for display, although the option of locally generated test pattern for diagnostic purposes may remain available. Moreover, although the external signal may continue to pass through decryption module 205, the external signal is not expected to be encrypted. Accordingly, decryption module 205 may be provided with a no-encryption, or inactive, mode, or appropriate multiplexer circuitry or other switching circuitry may be provided to bypass decryption module 205. Alternatively, decryption module 205 may continue to operate, preferably with a fixed key, and an encryption module, similar to encryption module 215, may be provided in the electronic device, again with a fixed key.

A bit-error rate tester incorporating the present invention may be used in conjunction with the device testing method and architecture described in copending, commonly-assigned U.S. patent application Ser. No. 12/239,878, filed Sep. 29, 2008, which is hereby incorporated by reference in its entirety.

The techniques of the present invention may be used in such a testing architecture, for example, to determine an optimum slew rate for high-speed data. A higher slew rate may be preferable, but may be expected to generate more electromagnetic interference, increasing the bit-error rate. Thus, the slew rate may be varied while the bit-error rate is monitored in accordance with the present invention to find the minimum bit-error rate, or the best compromise of bit-error rate and slew rate (i.e., the slew rate providing the maximum tolerable bit-error rate, or at which the bit-error rate becomes noticeable).

Similarly, DC bias of display 101 increases power consumption, but reduced DC bias may increase the bit-error rate. Thus, the DC bias may be varied while the bit-error rate is monitored in accordance with the present invention to find the minimum bit-error rate, or the best compromise of bit-error rate and DC bias (i.e., the DC bias providing the maximum tolerable bit-error rate, or at which the bit-error rate becomes noticeable).

As described in above-incorporated application Ser. No. 12/239,878, the terminal resistance of the transmitter sending a signal to display module 200 also may affect the bit-error rate. The terminal resistance of display module 200 may be determined, to allow it to be matched, by sweeping a variable terminal resistance 144 of transmitter 114 while measuring the bit-error rate in accordance with the invention, and noting the terminal resistance at which the bit-error rate is lowest.

Thus it is seen that apparatus and methods for robust testing of a peripheral component of a device, using variable test patterns, have been provided. It will be understood that the foregoing is only illustrative of the principles of the invention, and that various modifications can be made by those skilled in the art without departing from the scope and spirit of the invention, and the present invention is limited only by the claims that follow.

What is claimed is:

1. A system comprising:
a peripheral component of an electronic device, the peripheral component having:
a driver including testing circuitry, wherein:
the testing circuitry includes receiver pattern circuitry for generating a varying receiver test pattern based on a receiver pattern input value; and
apparatus for testing the peripheral component, the apparatus comprising:
transmitter pattern circuitry for generating a varying transmitter test pattern, and
circuitry for sending the transmitter test pattern to the testing circuitry; wherein:
the receiver pattern circuitry and the transmitter pattern circuitry operate identically, such that the receiver test pattern and the transmitter test pattern are identical when the receiver pattern input value and the transmitter pattern input value are identical; the system further comprising:
input circuitry for inputting an initial value as both the receiver pattern input value and the transmitter pattern input value; and
comparator circuitry in the testing circuitry that compares the transmitter test pattern received from the testing apparatus to the receiver test pattern.

2. The system of claim 1 wherein:
the circuitry for sending the transmitter test pattern to the testing circuitry comprises a first serial link; and
the input circuitry for inputting an initial value as both the receiver pattern input value and the transmitter pattern input value comprises a second serial link.

3. The system of claim 2 wherein:
the first serial link is a MIPI serial link; and
the second serial link is a MIPI low-power serial link.

4. The system of claim 1 wherein:
the receiver pattern circuitry and the transmitter pattern circuitry comprise identical linear-feedback shift registers; and
the initial value is a seed value for the linear-feedback shift registers.

5. The system of claim 4 further comprising circuitry for reseeding each of the linear-feedback shift registers from its own respective output.

6. The system of claim 5 wherein the circuitry for reseeding comprises a respective multiplexer for selecting among portions of the respective output.

7. The system of claim 6 wherein:
the circuitry for reseeding comprises a respective second linear-feedback shift register for generating a selection control input for the respective multiplexer; and
the second linear-feedback shift registers are seeded identically.

8. The system of claim 1 further comprising:
encryption circuitry that operates on the transmitter test pattern to encrypt the transmitter test pattern before the transmitter pattern is sent to the testing circuitry; and
decryption circuitry in the testing circuitry that operates on the received encrypted transmitter test pattern before the comparator compares the transmitter test pattern to the receiver test pattern.

9. The system of claim 8 further comprising key circuitry for providing complementary encryption and decryption keys to the encryption circuitry and the decryption circuitry.

10. A method of using a testing apparatus to test a peripheral component of an electronic device, the method comprising:
sending an initial value to the testing apparatus and to the peripheral component;
using the initial value as a seed value in the peripheral component to generate a receiver test pattern;
using the initial value as a seed value in the testing apparatus to generate a transmitter test pattern; wherein:
the peripheral component and the testing apparatus operate identically on the seed value to generate the receiver test pattern and the transmitter test pattern;
sending the transmitter test pattern to the peripheral component; and
comparing, in the testing circuitry, the transmitter test pattern received from the testing apparatus to the receiver test pattern.

11. The method of claim 10 further comprising reseeding the peripheral device and the testing apparatus with corresponding portions of the receiver test pattern and the transmitter test pattern.

12. The method of claim 10 further comprising:
encrypting the transmitter test pattern in the testing apparatus before the transmitter pattern is sent to the peripheral component; and
decrypting the received encrypted transmitter test pattern in the peripheral component before comparing the transmitter test pattern to the receiver test pattern.

13. The method of claim 12 further comprising providing complementary encryption and decryption keys to the testing apparatus and the peripheral component.

14. Testing circuitry in a peripheral component of an electronic device, the testing circuitry comprising:
component pattern circuitry for generating a varying component test pattern based on a pattern input value;
comparator circuitry that compares the component test pattern to an external test pattern received from external testing apparatus;
first input circuitry for receiving the pattern input value; and
second input circuitry for receiving the external test pattern.

15. The testing circuitry of claim 14 wherein:
the component pattern circuitry comprises a linear-feedback shift registers; and
the pattern input value is a seed value for the linear-feedback shift register.

16. The testing circuitry of claim 20 wherein the input circuitry further comprises circuitry for reseeding the linear-feedback shift register from its own output.

17. The testing circuitry of claim 16 wherein the circuitry for reseeding comprises a multiplexer for selecting among portions of the respective output.

18. The testing circuitry of claim 17 wherein the circuitry for reseeding comprises a second linear-feedback shift register for generating a selection control input for the multiplexer.

19. The testing circuitry of claim 14 further comprising decryption circuitry that operates on the received external test pattern before the comparator compares the external test pattern to the component test pattern.

20. Testing apparatus for testing a peripheral component of an electronic device, wherein the peripheral component has a driver including testing circuitry, and the testing circuitry includes (a) receiver pattern circuitry for generating a varying receiver test pattern based on a receiver pattern input value and (b) comparator circuitry that compares a transmitter test pattern received from the testing apparatus to the receiver test pattern; the testing apparatus comprising:
transmitter pattern circuitry for generating a varying transmitter test pattern, and
circuitry for sending the transmitter test pattern to the testing circuitry; wherein:
the transmitter pattern circuitry operates identically to the receiver pattern circuitry and, such that the receiver test pattern and the transmitter test pattern are identical when the receiver pattern input value and the transmitter pattern input value are identical; the apparatus further comprising:
input circuitry for inputting an initial value as both the receiver pattern input value and the transmitter pattern input value.

21. The testing apparatus of claim 20 wherein:
the transmitter pattern circuitry comprises a linear-feedback shift register; and
the initial value is a seed value for the linear-feedback shift register.

22. The testing apparatus of claim 21 wherein the input circuitry further comprises circuitry for reseeding the linear-feedback shift register from its own output.

23. The testing apparatus of claim 22 wherein the circuitry for reseeding comprises a multiplexer for selecting among portions of the output.

24. The testing apparatus of claim 23 wherein:
the circuitry for reseeding comprises a second linear-feedback shift register for generating a selection control input for the multiplexer.

25. The testing apparatus of claim 20 further comprising:
encryption circuitry that operates on the transmitter test pattern to encrypt the transmitter test pattern before the transmitter pattern is sent to the testing circuitry.

26. The testing apparatus of claim 25 further comprising key circuitry for providing complementary encryption and decryption keys to the encryption circuitry and to decryption circuitry in the testing circuitry.
